(19) United States
(12) Patent Application Publication
(10) Pub. No.: US 2026/0266255 A1
(43) Pub. Date: Sep. 10, 2026

(54) Wave Energy Powered Underwater Vehicle

(71) Applicant: Alliance for Energy Innovation, LLC, Golden, CO (US)

(72) Inventors: Jochem Wilhelm WEBER, Lyons, CO (US); Salman HUSAIN, Superior, CO (US)

(21) Appl. No.: 19/557,418

(22) Filed: Mar. 5, 2026

Related U.S. Application Data
(60) Provisional application No. 63/767,097, filed on Mar. 5, 2025.

(51) Int. Cl. F03B 13/20; B63G 8/00; B63H 21/17

(52) U.S. Cl. CPC F03B 13/20; B63G 8/001; B63H 21/17; B63G 2008/004

(57) ABSTRACT

An underwater vehicle capable of operating in a charging mode where electrical energy may be harvested from wave action and stored in a battery and a discharging mode where the battery is used to power the device. Charging may include allowing the underwater vehicle to be positioned substantially perpendicular in the water. This may allow the hull and at least one fin to move counter to each other (in some embodiments out of sync with each other) to generate electrical energy.

### CROSS-REFERENCE TO RELATED APPLICATIONS

This application claims priority from U.S. Provisional Patent Application No. 63/767,097 filed on Mar. 5, 2025, the contents of which are incorporated herein by reference in their entirety.

### CONTRACTUAL ORIGIN

This invention was made with government support under Contract No. DE-AC36-08GO28308, awarded by the Department of Energy. The government has certain rights in this invention.

### BACKGROUND

Most ocean observation systems are powered by onboard energy storage technology, such as batteries. Onboard energy storage often requires external (often on land or at the mission start point), separate energy sources to fuel or recharge the ocean observation system. Some ocean observation systems use onboard renewable energy sources, however, most of these require the ocean observation system to operate at the ocean surface (i.e., solar or wind power). Thus, there remains a need for ways to power ocean observation systems for ocean and subsurface operations with minimal interruptions to their performance.

### SUMMARY

An aspect of the present disclosure is an underwater vehicle including a hull having an end, a first hinge connected to the end, a first flap connected to the first hinge, a second hinge connected to the end, and a second flap connected to the second hinge, in which the first hinge includes a first power take off (PTO) component, the first PTO component can convert a first movement of the first hinge to an electrical energy, the second hinge includes a second PTO component, the second PTO component can convert a second movement of the second hinge to an electrical energy, and the first movement and the second movement may be caused by a wave action. In some embodiments, the first movement includes a change of an angle between the first flap and the hull, and the angle is acute. In some embodiments, the second movement includes a changing of an angle between the second flap and the hull, and the angle is acute. In some embodiments, the first movement and the second movement are out of phase. In some embodiments, the first flap and the second flap include planar surfaces. In some embodiments, the underwater vehicle can be operated in a charging mode and a discharging mode, and during the charging mode the PTO component can convert a movement of the hinge to an electrical energy. In some embodiments, the underwater vehicle includes a battery and during the charging mode the electrical energy is stored in a battery. In some embodiments, the underwater vehicle also includes a propeller and during the discharging mode the battery is used to power the propeller, and when powered the propeller can move the underwater vehicle through a water. In some embodiments, the underwater vehicle includes a sensor and during discharging the battery is used to power the sensor. In some embodiments the underwater vehicle includes a fin including a planar surface, in which the hull includes a length, and a fin is connected to the length.

An aspect of the present disclosure is a method including operating an underwater vehicle in a charging mode, and operating the underwater vehicle in a discharging mode, in which the underwater vehicle includes a hull having an end, a first hinge comprising a first power take off (PTO) component and connected to the end, a first flap connected to the first hinge, a second hinge including a second PTO component and connected to the end, and a second flap connected to the second hinge, and the charging mode includes using the first PTO component to convert a change in an angle between the first flap and the hull to electrical energy, the charging mode includes using the second PTO component to convert a change in an angle between the second flap and the hull to electrical energy, the charging mode includes storing the electrical energy in a battery, the discharging mode includes using the electrical energy to power to underwater vehicle.

An aspect of the present disclosure is an underwater vehicle including a hull having an end and a length, a hinge connected to the end, and a flap connected to the hinge, in which the hinge includes a power take off (PTO) component, the PTO component can to convert a movement of the hinge to an electrical energy, and the movement is caused by a wave action. In some embodiments, the movement includes a changing of an angle between the flap and the hull, and the angle is obtuse. In some embodiments, the flap includes a planar surface. In some embodiments, the length includes a fin, and the fin includes a planar surface. In some embodiments, the fin is connected to the hinge, the movement includes a changing of an angle between the flap and the fin, and the angle is obtuse. In some embodiments, the underwater vehicle can be operated in a charging mode and a discharging mode, and during the charging mode the PTO component can convert a movement of the hinge to an electrical energy. In some embodiments, the underwater vehicle includes a battery and during the charging mode the electrical energy is stored in a battery. In some embodiments, the underwater vehicle includes a propeller and during the discharging mode the battery is used to power the propeller, and when powered the propeller can move the underwater vehicle through a water. In some embodiments, the underwater vehicle also includes a sensor and during discharging the battery is used to power the sensor.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1 illustrates a first embodiment of an underwater vehicle powered by wave energy according to some aspects of the present disclosure.

FIG. 2 illustrates a second embodiment of an underwater vehicle power by wave energy according to some aspects of the present disclosure.

FIG. 3A illustrates a free body diagram of a first embodiment and FIG. 3B illustrates a free body diagram of a second embodiment of an exemplary underwater vehicle capable of recharging using wave energy.

FIG. 4 illustrates pitch response amplitude operators (RAOs) for the reference models of an underwater vehicle capable of recharging using wave energy, according to some aspects of the present disclosure.

FIG. 5 illustrates device pitch response amplitudes for an underwater vehicle capable of recharging using wave energy, according to some aspects of the present disclosure.

FIG. 6 illustrates average power for a range of sea states for an underwater vehicle capable of recharging using wave energy, according to some aspects of the present disclosure.

FIG. 7 illustrates power conversion efficiency for an underwater vehicle capable of recharging using wave energy, according to some aspects of the present disclosure.

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

Among other things, the present disclosure includes an underwater vehicle capable of operating in a charging mode where electrical energy may be harvested from wave action and stored in a battery and a discharging mode where the battery is used to power the device. Charging may include allowing the underwater vehicle to be positioned substantially perpendicular in the water. This may allow the hull and at least one fin to move counter to each other (in some embodiments out of sync with each other) to generate electrical energy.

In some embodiments, when the underwater vehicle is operating in the discharging mode it is substantially parallel to the sea floor. That is, the underwater vehicle is positioned such that the hull is substantially horizontal as the underwater vehicle moves through the water. In the discharging mode the movement of the underwater vehicle may be powered by an engine, which may include a propeller or turbine to provide thrust, and that engine may be powered by a battery within the hull. The battery may also power onboard ocean observation equipment, such as sensors (e.g., temperature or pressure sensors), videographic or photographic equipment, and/or sampling devices. The underwater vehicle may also contain robotic sample collecting mechanisms on board. The underwater vehicle may also contain a processor and other computer equipment responsible for driving/steering the vehicle, recording information collected by the sensors, and/or communicating with computers out of the water. This processor may also be powered by the battery in the discharging mode.

In some embodiments, when the underwater vehicle is operating in the charging mode it is substantially perpendicular to the sea floor. That is, the underwater vehicle is positioned such that the hull is substantially vertical. The engine may be turned off or inactivated in this mode. When in the charging mode the movement of the hull and flap(s) as a result of surrounding wave action may be used to generate electrical energy to charge the battery.

In some embodiments, the devices may be used for sustained ocean observation by mobile ocean systems powered by ocean wave energy and capable of operating throughout the water column. The underwater vehicles described herein may combine a mobile platform (i.e., the hull) to house and operate motion observation, monitoring, and measurement systems, propulsion of the device throughout the water column and across/around the ocean, and ocean wave energy extraction and conversion to an operation-relevant energy form (i.e., electrical energy). The underwater vehicles may charge using movement angles between the main body or hull of the underwater vehicle and at least one flap. In some embodiments, the hull and the flap may move out of sync.

In some embodiments, the device may be an autonomous underwater vehicle (AUV), underwater data glider, or other submarine/underwater vehicle. The ocean observation system may have at least one propulsion technology/capability, allowing it to move through the ocean under the surface of the water during the discharging mode. Exemplary propulsion technologies may include a propeller, which may be in the front or rear of the device. The discharging mode may be the “normal” operation of the device (i.e., when the device is performing ocean observation).

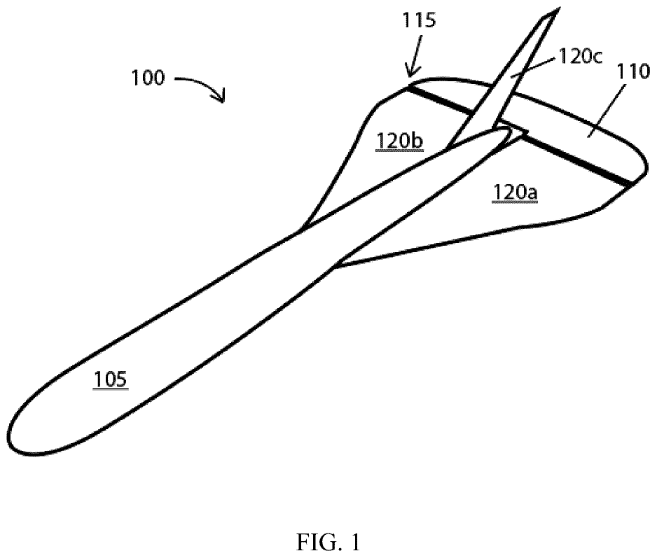

FIG. 1 illustrates a first embodiment of an underwater vehicle 100 powered by wave energy according to some aspects of the present disclosure. In some embodiments, the underwater vehicle 100 may include a pitching flap 110 hinged on the tail-end of an underwater vehicle 100 with a substantially cylindrical and/or conical hull 105. The axis of rotation between the hull 105 and the flap 110 in this embodiment is essentially above the hull 105. The hull 105 of the underwater vehicle 100 may be assumed to be substantially coaxial and include substantially fixed (i.e., stationary) fins 120 that act as anti-roll or hydro-foil features of the underwater vehicle 100 when it is moving forward using the propulsion capability. The flap 110 may be substantially ocean surface-piercing (i.e., it is in contact with the ocean surface) during the charging mode (i.e., during wave energy absorption operation) while the rest of the underwater vehicle 100 remains substantially submerged. That is, when the underwater vehicle 100 is in the discharging mode it may be oriented such that the flap 110 may be near the end or rear of the hull 105, and when the underwater vehicle 100 is in the charging mode the hull 105 may be oriented such that the flap 110 may be near the top of the hull 105.

In some embodiments, the hull 105 of the underwater vehicle 100 may have a substantially cylindrical cross-section which may be substantially uniform along the length of the hull 105. This design for the hull 105 may create a higher displaced volume for the underwater vehicle 100 during operating of the discharging mode of the underwater vehicle 100.

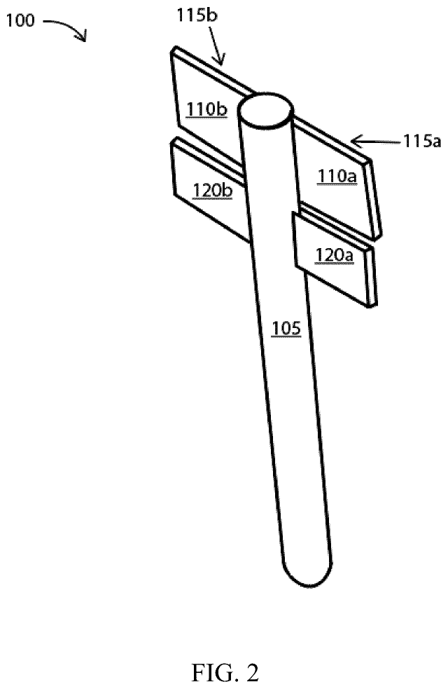

FIG. 2 illustrates a second embodiment of an underwater vehicle 100 power by wave energy according to some aspects of the present disclosure. Similar to the embodiment shown in FIG. 1, the underwater vehicle 100 may include a hull 105 with fins 120. A pair of flaps 110a and 110b may be connected to the hull 105 by a pair of hinges 115a and 115b. These flaps 110a-b may move in sync or out of sync with the hull 105. The movement of these flaps 110a-b as felt by the hinges 115a-b is what generates the electrical energy for the underwater vehicle 100.

In the embodiment shown in FIG. 2, the hull 105 and the flaps 110a-b may act as oscillators when charging. In some embodiments, they may oscillate (i.e., move somewhat rhythmically with wave action) in different phases, frequencies, or time, meaning they oscillate out of sync with each other. This dyssynchronous movement may result in greater movement felt by the hinges 115 and thus the power take off (PTO) components converting the movement to electrical energy. This out of phase movement may be aided by the presence of fins 120a-b on the hull 105, which may cause the hull 105 to oscillate at a different frequency than the flaps 110a-b.

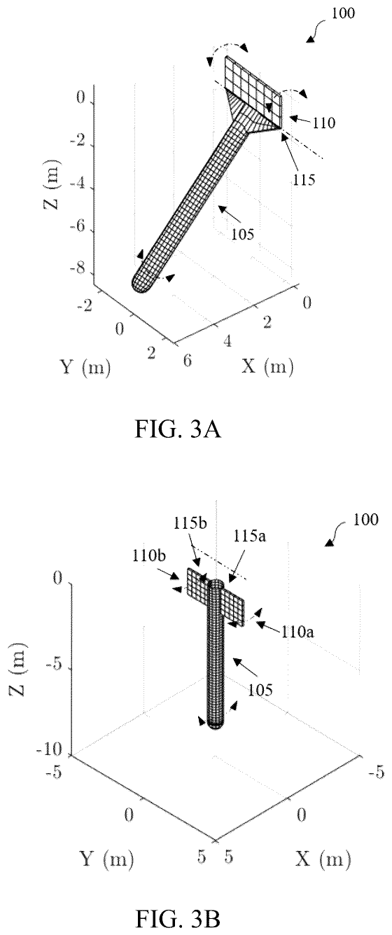

FIG. 3A illustrates a free body diagram of a first embodiment (i.e., the embodiment shown in FIG. 1) and FIG. 3B illustrates a free body diagram of a second embodiment (i.e., the embodiment shown in FIG. 2) of an exemplary underwater vehicle 100 capable of recharging using wave energy. The embodiment shown in FIG. 3A has the location of the axis between the flap (i.e., fin) 110 and the hull 105 at the very end (i.e., above) the hull 105, resulting in the entire underwater vehicle 100 moving as a single-hinged body (see FIG. 1). The curved arrows in FIG. 3A show the movement pattern of the flap 110 during the charging mode. The angle between the hull 105 and the flap 110 may be substantially obtuse (i.e., greater than approximately 90°) during normal charging mode operation.

The embodiment shown in FIG. 3B has the axis for a pair of flaps 110a and 110b and the hull 105 aligned and above both the hull 105 and the flaps 110a and 110b, along an increase in the excitation force experienced by the flaps 110 and the hull 105 (i.e., generating more power) (see FIG. 2). The curved arrows in FIG. 3B show the movement patterns of the flaps 110a-b during the charging mode. The embodiment shown in FIG. 3B may allow the flaps 110 and the hull 105 to be out-of-phase (i.e., their movements out of sync), substantially mutually counteracting each other and thereby increasing the relative motion and energy extracted. The flaps 110a-b may be connected to the hull 105 only at the axis of rotation (i.e., the top of the flaps 110a-b), allowing them to “swing” next to the hull 105. That is, the flaps 110a-b in FIG. 3B And FIG. 2 may be substantially parallel to the hull 105 but connected to the hull 105 such that they can move independently of the hull 105.

In some embodiments, electrical energy may be generated using at least one power take-off (PTO) connected to the hinge 115 at the axis between the hull 105 and the flap 110 of the underwater vehicle 100. The PTO may be substantially rotational and act as a spring damper that extracts incoming wave energy by counter-acting the relative rotational motion of the flap 110 and the underwater vehicle 100 (i.e., the change in angle between the flap 110 and the vehicle 100). Examples of PTO components may include turbine generators, air compressors or air pumps, electrical generators, hydraulic actuators, or any other device or system for power take off. The flaps 110 may include a substantially planar surface capable of catching/being moved by wave action.

In simulations, the embodiment shown in FIGS. 3B and 2 was shown to increase the relative motion between the hull 105 and the flaps 110a-b. By bifurcating the flap 110 into two flaps 110a and 110b, greater rotation of each individual flap 110a or 110b is possible without restricting the movement of the hull 105. Compared to the embodiment shown in FIG. 3A (and FIG. 1), the embodiment shown in FIG. 3B has the benefit of increasing the moment arm of the flap 110a or 110b (i.e., moving the center of gravity of the flap 110a or 110b away from the axis of rotation). In both embodiments shown in FIGS. 3A-B, increasing the flap 110 thickness may increase the fluid displaced by the flap 110 and thus restore buoyancy moment. In the embodiment shown in FIG. 3B, the moment of the weight force may restore the flap 110 to its mean (i.e., original or most common) position instead of being restored by buoyancy force. That is, the flaps 110a-b may have a weight.

As shown in FIG. 3B, the flaps 110a and 110b can have their axis to the top end of the hull 105 (i.e., the axis is such that the weight moment seeks to move the flap 110 hanging substantially vertically) while hydrodynamic forces and moments try to move the flap 110 away from the equilibrium position. That is, while the axis/hinge 115 is at the same location (the end of the hull 105) in both FIG. 3A and FIG. 3B., the flap 110 has a different direction in each. In the embodiment shown in FIG. 3A, the flap 110 extends away from the hull 105 and the angle between them may be substantially obtuse. In the embodiment shown in FIG. 1B the flaps 110a and 100b are substantially parallel to the hull 105, and the angle between them may be substantially acute (i.e., less than approximately 90)°. The embodiment shown in FIG. 3B may result in a more stable equilibrium position, and the opposing sense of rotation of the weight and hydrodynamic moments enhances the relative motion between the flaps 110a and 110b and the hull 105 by introducing a counteracting phase between the two bodies. As the axis is moved away from the underwater vehicle's 100 center of gravity, the pitch moment of inertia of the underwater vehicle 100 increases. As shown in the embodiment in FIG. 1B, the axis of rotation is moved vertically up the hull 105, from which the flaps 110 and the hull 105 “hang” as pendulums. The difference in the moments of inertia, and the hydrodynamic forces on the two bodies can then be exploited for better power extraction by the PTO at the raised external axis (i.e., in the hinge 115).

In some embodiments, the flaps 110 are substantially planar surfaces that are approximately 1.5 m in width and height, which a thickness of approximately 0.1 m. The hull 105 may be approximately 8.4 m in length with a width of approximately 0.8 m. These dimensions are only exemplary and were used for calculations. The hull 105 may be substantially cylindrical with a substantially circular or ellipsoidal cross section. The PTO was assumed to be a system made of torsional-spring and-damper that could potentially be tuned and optimized for the prevailing sea-states. The PTO may be connected to the hinge 115 such that it can convert the movement between the hull 105 and the flap 110 into electrical energy during the charging mode.

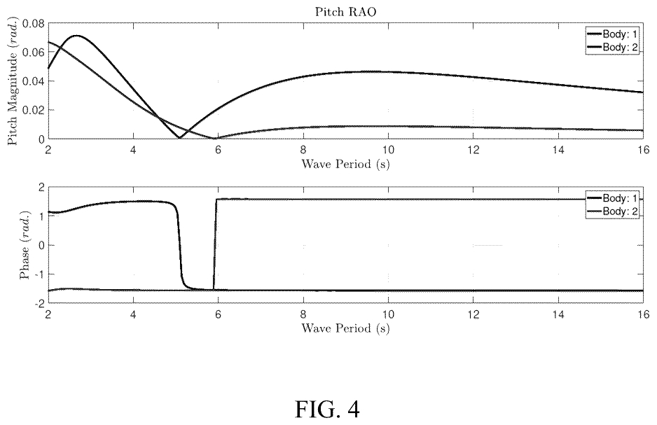

The embodiment shown in FIG. 2 was analyzed in frequency-domain and in time-domain. The results from these analyses are shown in FIG. 4. The frequency-dependent hydrodynamic coefficients were generated using a boundary element method (BEM) solver. The BEM solver evaluated the hydrodynamic coefficients at user-defined body-frames and also allowed for evaluating the response amplitude operators (RAOs) while restricting user-defined degrees of freedom (DOF) while introducing external forces in terms of external inertia, stiffness, and damping matrices. FIG. 4 shows the RAOs for the embodiment shown in FIG. 2 in the pitch mode (i.e., in the charging mode). The RAOs were plotted against wave-periods for easier comparison with the power matrices generated using the time-domain models, where the wave-periods Tₚ(s) are related to the wave frequency ω by

$${T}_{p} = \frac{2 pi}{ω} .$$

Note that in FIG. 4, “Body 1” refers to a single flap 110a or 110b and “Body 2” refers to the hull 105.

In some embodiments, the dynamic response of the underwater vehicle 100 is almost the same regardless of the number of flaps 110 or fins 120, and the response of the underwater vehicle 100 is substantially agnostic to the flap 110 dimensions, which may be attributed to the relatively significantly larger size of the hull 105 when compared to the flap 110. Higher pitch responses may be seen in underwater vehicles 100 with flaps 110 with the deeper draughts (i.e., the distance between the axis and the flap 110 center of gravity) (see FIG. 3B). The deeper draught may entail higher hydrodynamic coupling between the flap 110 and the hull 105. In some embodiments, fins 120 may introduce a counter phase between the hull 105 and the flap(s) 110.

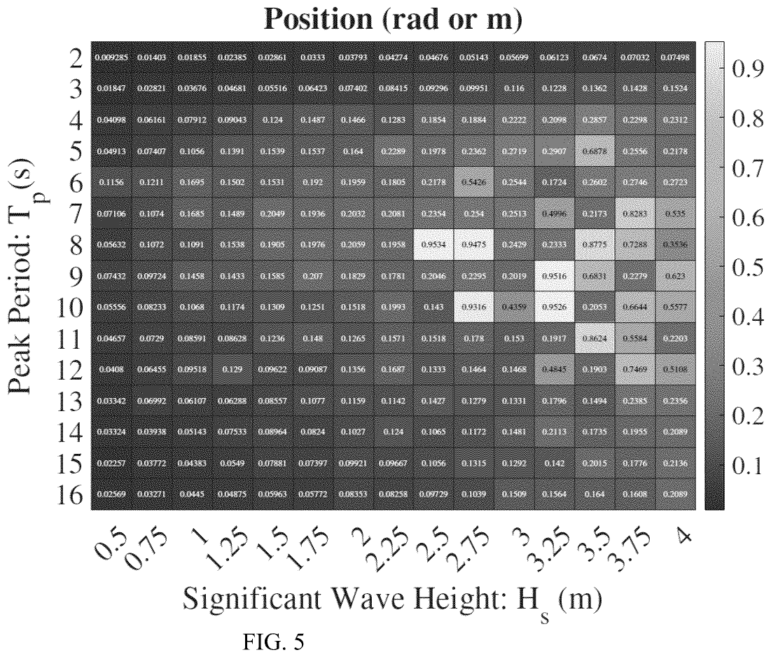

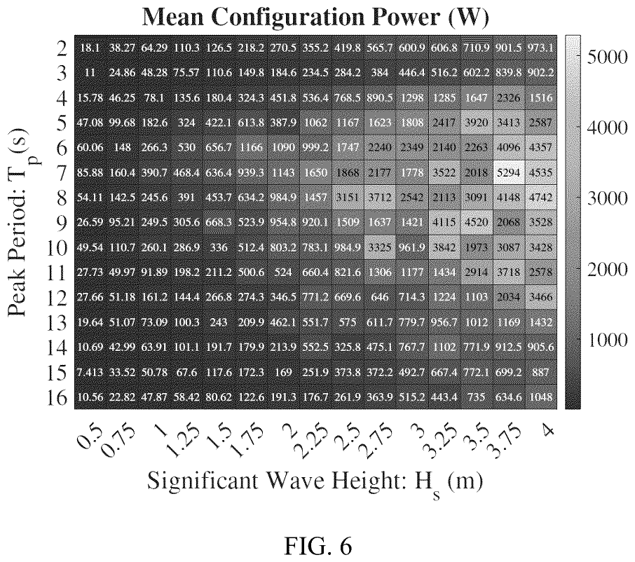

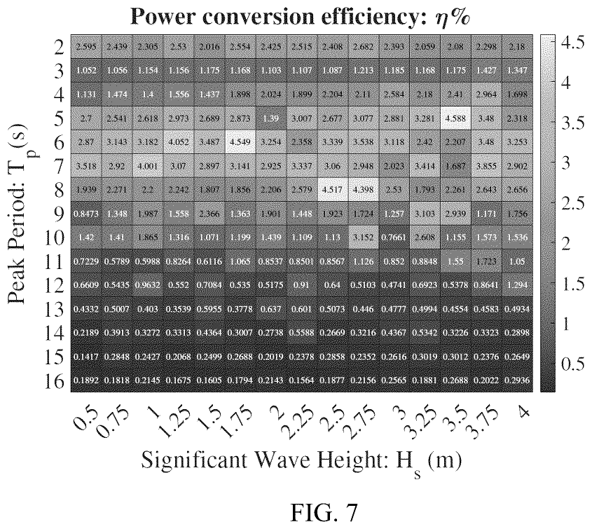

The embodiment shown in FIG. 2 was simulated for approximately 225 sea states made up of wave-heights: Hₛ(m)ϵ{0.5,0.75, . . . 4} m and wave-periods: Tₚ(s)ϵ{2,3, . . . 16} s. The results are shown in FIGS. 5-7. FIG. 5 illustrates underwater vehicle 100 pitch response amplitudes for the range of sea states, according to some aspects of the present disclosure. The amplitude of the pitch motion of the flap 110 is shown in radians. The amplitude was evaluated using a Fourier transform of the time-history of the pitch motion. FIG. 6 illustrates average power for the sea states for the underwater vehicle 100 embodiment shown in FIG. 2, according to some aspects of the present disclosure. FIG. 7 illustrates extraction efficiency of power generated by the underwater vehicle 100 as shown in the embodiment in FIG. 2 as a percentage of incident power, according to some aspects of the present disclosure.

For FIGS. 5-7, the estimated PTO stiffness was set to be approximately equal to the hydrostatic stiffness constant of the flap 110 in pitch, K_{H}, and the PTO damping was evaluated using impedance matching, such that

$${K}_{θ} = {K}_{H}$$

$${C}_{θ} = B ( ω ) \sqrt{1 + ( \frac{{K}_{H} - {ω}^{2} ( M + {a}_{∞} )}{ω B ( ω )} )}$$

where ω is the pertinent wave-frequency, K_{θ} and C_{θ} are the PTO stiffness and damping, B(ω) is the flap's 110 radiation damping in pitch at a given ω, M is the flap's pitch moment of inertia, and ax is the flap's 110 pitch added-mass at infinite-frequency.

Overall underwater vehicle 100 device characterization in terms of device capacity can be described using annual energy production (AEP) calculations. The AEP takes the weighted-sum of the energy extracted by the device (i.e., the underwater vehicle 100) while factoring in the variability of sea-states. The AEP estimates can be used to identify the parameters for the electrical components such as the battery, processor, and other components. Additionally, the AEP can serve as a device characteristic and could be used to compare the underwater vehicle 100 of the present disclosure with other similar devices. The annual average power (AAP) may be calculated by taking the weighted-sum of the average power for the assorted sea-states identified using the observed data. The AAP can be used to do approximate mission-planning and in the estimates of energy-balance and energy-management.

TABLE 1
AAP for the embodiment shown in FIG. 1 at a range of deployment sites

| | | | | AAP for |
|---|---|---|---|---|
| | | Nearest | | embodiment |
| | | Buoy | Dominant | shown |
| Site | Coordinates | ID | [H(m), T(s)] | in FIG. 1 |
| CalWave, CA | [34.521, −120.689] | 46218 | [2.25 m, 10.5 s] | 240 |
| Humboldt, CA | [40.841, −124.248] | 46212 | [1.25 m, 7.25 s] | 289 |
| Jennette's Pier, NC | [35.912, −75.586] | 44095 | [0.75 m, 5.50 s] | 186 |
| Pac Wave, OR | [44.689, −124.135] | 44094 | [1.25 m, 8.50 s] | 302 |
| Duck, NC | [36.185, −75.748] | 44056 | [0.75 m, 5.50 s] | 158 |
| Oahu, HI | [21.475, −157.755] | 51207 | [1.75 m, 6.50 s] | 284 |
| Western, AK | [50.005, −166.995] | 46072 | [0.75 m, 5.50 s] | 804 |

As shown in Table 1, the embodiment shown in FIG. 1 produces an AAP ranging from approximately 150 W to approximately 800 W. For these calculations, the underwater vehicle 100 had a volume of approximately 4.22 m³. Thus, the underwater vehicle 100 is able to meet or exceed the energy demands of comparable submersible devices (approximately 500 W). To achieve the needed power generation the underwater vehicle 100 may need to spend approximately 50% of the time in charging mode and approximately 50% of the time in discharging mode. Note that discharge mode could be longer if the underwater vehicle 100 operates in a glider mode (i.e., moving without running engines/turbines).

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. An underwater vehicle comprising:
a hull having an end;
a first hinge connected to the end;
a first flap connected to the first hinge;
a second hinge connected to the end; and
a second flap connected to the second hinge; wherein:
the first hinge comprises a first power take off (PTO) component,
the first PTO component is configured to convert a first movement of the first hinge to an electrical energy,
the second hinge comprises a second PTO component,
the second PTO component is configured to convert a second movement of the second hinge to an electrical energy, and
the first movement and the second movement may be caused by a wave action.

2. The underwater vehicle of claim 1, wherein:
the first movement comprises a changing of an angle between the first flap and the hull, and
the angle is acute.

3. The underwater vehicle of claim 1, wherein:
the second movement comprises a changing of an angle between the second flap and the hull, and
the angle is acute.

4. The underwater vehicle of claim 1, wherein:
the first movement and the second movement are out of phase.

5. The underwater vehicle of claim 1, wherein:
the first flap and the second flap comprise planar surfaces.

6. The underwater vehicle of claim 1, wherein:
the underwater vehicle is configured to be operated in a charging mode and a discharging mode, and
during the charging mode the PTO component is configured to convert a movement of the hinge to an electrical energy.

7. The underwater vehicle of claim 6, further comprising:
a battery; wherein:
during the charging mode the electrical energy is stored in a battery.

8. The underwater vehicle of claim 6, further comprising:
a propeller, wherein:
during the discharging mode the battery is used to power the propeller, and
when powered the propeller is configured to move the underwater vehicle through a water.

9. The underwater vehicle of claim 6, further comprising:
a sensor; wherein:
during discharging the battery is used to power the sensor.

10. The underwater vehicle of claim 1, further comprising:
a fin comprising a planar surface; wherein:
the hull comprises a length, and
a fin is connected to the length.

11. A method comprising:
operating an underwater vehicle in a charging mode; and
operating the underwater vehicle in a discharging mode; wherein:
the underwater vehicle comprises:
a hull having an end;
a first hinge comprising a first power take off (PTO) component and connected to the end;
a first flap connected to the first hinge;
a second hinge comprising a second PTO component and connected to the end; and
a second flap connected to the second hinge;
the charging mode comprises using the first PTO component to convert a change in an angle between the first flap and the hull to electrical energy,
the charging mode comprises using the second PTO component to convert a change in an angle between the second flap and the hull to electrical energy,
the charging mode comprises storing the electrical energy in a battery, and
the discharging mode comprises using the electrical energy to power to underwater vehicle.

12. An underwater vehicle comprising:
a hull having an end and a length;
a hinge connected to the end; and
a flap connected to the hinge; wherein:
the hinge comprises a power take off (PTO) component,
the PTO component is configured to convert a movement of the hinge to an electrical energy, and
the movement is caused by a wave action.

13. The underwater vehicle of claim 12, wherein:
the movement comprises a changing of an angle between the flap and the hull, and
the angle is obtuse.

14. The underwater vehicle of claim 12, wherein:
the flap comprises a planar surface.

15. The underwater vehicle of claim 12, wherein:
the length comprises a fin, and
the fin comprises a planar surface.

16. The underwater vehicle of claim 15, wherein:
the fin is connected to the hinge,
the movement comprises a changing of an angle between the flap and the fin, and
the angle is obtuse.

17. The underwater vehicle of claim 12, wherein:
the underwater vehicle is configured to be operated in a charging mode and a discharging mode, and
during the charging mode the PTO component is configured to convert a movement of the hinge to an electrical energy.

18. The underwater vehicle of claim 17, further comprising:
a battery; wherein:
during the charging mode the electrical energy is stored in a battery.

19. The underwater vehicle of claim 17, further comprising:
a propeller; wherein:
during the discharging mode the battery is used to power the propeller, and
when powered the propeller is configured to move the underwater vehicle through a water.

20. The underwater vehicle of claim 17, further comprising:
a sensor; wherein:
during discharging the battery is used to power the sensor.
